(19) United States
(12) Patent Application Publication
(10) Pub. No.: US 2013/0003369 A1
(43) Pub. Date: Jan. 3, 2013

(54) LIGHTING APPARATUS

(76) Inventors: Jun Hiraoka, Osaka-shi (JP); Ken Ueda, Osaka-shi (JP); Tsutomu Satoh, Osaka-shi (JP); Masanori Morigami, Osaka-shi (JP)

(21) Appl. No.: 13/634,173

(22) PCT Filed: Mar. 4, 2011
(86) PCT No.: PCT/JP2011/055063

§ 371 Date: Sep. 11, 2012

(30) Foreign Application Priority Data
Mar. 12, 2010 (JP) 2010-056367

(51) Int. Cl. F21V 7/00; F21V 9/00

(52) U.S. Cl. 362/231; 362/235; 362/296.01; 362/298

(57) ABSTRACT

A lighting apparatus includes a LED module provided at the central side of a chassis and a reflection sheet reflecting light emitted from the LED module. The LED module emits light to the outer edge portion of the chassis and then the light is reflected on the reflection sheet to perform illumination so that glare can be reduced. Then, the light emitted from the LED module is reflected on the reflection sheet in many directions so that a substantially uniform illuminated light with less illumination unevenness can be achieved. The LED module is not arranged at the outer edge portion of the chassis so that moment acting on the chassis can be reduced. Therefore, the deformation of chassis can be prevented.

This application is the national phase under 35 U.S.C. §371 of PCT International Application No. PCT/JP2011/055063 which has an International filing date of Mar. 4, 2011 and designated the United States of America.

### BACKGROUND

1. Technical Field

The present invention relates to a lighting apparatus provided with a light source and a reflecting section reflecting light emitted from the light source.

2. Description of Related Art

Conventionally, a lighting apparatus provided with a light source such as an incandescent light bulb, a fluorescent light and the like is used as the lighting apparatus to be utilized in indoor illumination in a residential building and the like. In recent years, due to the high luminance of a light emitting diode (hereinafter referred to as LED), a lighting apparatus provided with a LED as a light source having properties of compact, lower power consumption, longer durability and the like is proposed to replace a conventional light source (for example, see Japanese Patent Application Laid-Open No. 2008-300203).

The lighting equipment disclosed in Japanese Patent Application Laid-Open No. 2008-300203 is provided with a lighting equipment main body (corresponding to a chassis as a lighting apparatus main body) 610, semiconductor light emitting devices (corresponding to a light source) 621 arranged on outer edge portions 614, 615 of the lighting equipment main body 610 in a prescribed manner, a lens body 630 arranged opposite to the direction of light emission from the semiconductor light emitting devices 621 for controlling mainly light emitted from the semiconductor light emitting devices 621 in parallel direction, a reflector 640 facing to the semiconductor light emitting devices 621 and inclined towards substantially central side of the lighting equipment main body 610, a globe 650 covering the semiconductor light emitting devices 621 and the reflector 640 (see FIG. 21). The lighting equipment main body 610 has a rectangular plate shape and is provided with an adaptor 612 fitted to a suspended ceiling device 611 at the substantially central side.

The lighting equipment related to Japanese Patent Application Laid-Open No. 2008-300203 is utilized as a so-called ceiling light, in which the lighting equipment main body 610 is attached to an equipment clamp face A by engaging the adaptor 612 to the suspended ceiling device 611 arranged on the equipment clamp face A such as a ceiling plane and the like of a residential building and so on. Due to a lighting of the lighting equipment, the light emitted from the semiconductor light emitting devices 621 is in parallel direction relative to the lens body 630. In other words, the light is emitted to the inclined portion of the reflector 640 and then the light is further reflected on the reflector 640 and incident on the globe 650.

### SUMMARY

However, with regard to the lighting equipment related to Japanese Patent Application Laid-Open No. 2008-300203, semiconductor light emitting devices 621 as light sources are provided on outer edge portions 614, 615 of a lighting equipment main body 610; therefore, the weight of the semiconductor light emitting devices 621 as light sources and the wires are loaded on the outer edge portions 614, 615 of the lighting equipment main body 610. The lighting equipment related to Japanese Patent Application Laid-Open No. 2008-300203, as described above, is configured to be secured on the attaching material located at the center of the lighting equipment main body 610.

Since the weight is loaded on the outer edge portions 614, 615 of the lighting equipment main body 610, the moment and large downward force act on the distance between the fulcrum and load center (the distance between the outer edge portions 614, 615 and the light equipment main body 610). As a result, the deformation such as bending and the like may be appeared on the lighting equipment main body 610.

In view of the present invention, it aims to provide a lighting apparatus for preventing the deformation such as bending of the lighting apparatus main body.

A lighting apparatus related to the present invention is provided with a light source arranged at the central side of a lighting apparatus main body, and a reflecting section reflecting light emitted from the light source. The light source emits light towards an outer edge portion of the light apparatus main body, and the light is reflected on the reflecting section to perform illumination.

The present invention is provided with the light source arranged at the central side of the lighting apparatus main body, and the reflecting section reflecting light emitted from the light source. The light source emits light towards the outer edge portion of the light apparatus main body, and the light is reflected on the reflecting section to perform illumination. The light source is provided at the central side of the lighting apparatus main body. The light source is not arranged at the outer edge portion of the lighting apparatus main body; therefore, the moment acting on the lighting apparatus main body can be reduced so that the deformation of the light apparatus main body can be prevented, as comparing to a case where the light source is arranged at the outer edge portion of the lighting apparatus main body.

With regard to the lighting apparatus related to the present invention, the reflecting section includes a reflection surface opposite to the direction of light emission from the light source.

In the present invention, a reflection surface at the reflecting section facing to direction of light emission from the light source is formed, therefore, the light emitted from the light source is diffused at the reflection surface of the reflecting section. In other words, the light is reflected in many directions. A part of the diffused light is further reflected on the other portion of the reflecting section, other part of the diffused light exits to outside of the lighting apparatus without being incident on the reflecting section. As a result, a substantially uniform illumination with less illumination unevenness can be achieved.

The lighting apparatus related to the present invention includes another reflecting section, provided at the opposite side of the reflecting section with respect to the light source, and reflecting light emitted from the light source to the side of the reflecting section.

The present invention is provided with another reflecting section reflecting light emitted from the light source to the side of the reflecting section, at the opposite side of the reflecting section with respect to the light source. Therefore, direct light from the light source exiting from the vicinity of the light source to outside of the lighting apparatus can be prevented so that the glare can be further reduced while achieving a substantially uniform illumination with reducing illumination unevenness.

With regard to the lighting apparatus related to the present invention, the light source includes a plurality of light source elements with different color temperature. The light source element with higher color temperature is arranged at the farther side from the reflecting section than the light source element with lower color temperature.

In the present invention, the light source element with higher color temperature is arranged at the farther side from the reflecting section than the light source element with lower color temperature. For example, in a case where a light source element with daylight color and a light source element with incandescent color are used as the light source element, the eye-catching daylight color light source element with higher color temperature is arranged at the farther side from the reflecting section than the light source element with incandescent color, therefore, the amount of light with daylight color exiting to outside of the lighting apparatus can be reduced so that the glare can be further reduced. As a result, illumination unevenness can be further reduced so that a substantially uniform illumination can be achieved.

The lighting apparatus related to the present invention is provided with a light-diffusible cover covering the light source and the reflecting section. An inclined portion inclined towards the reflecting section is provided at the outer edge portion of the cover.

In the present invention, the inclined portion inclined towards the reflecting section is provided on the outer edge portion of the light-diffusible cover covering the light source and the reflecting section. By appropriately setting the inclined angle of the inclined portion, a part of light emitted from the light source is mirror-reflected at the inclined portion and then the light can exit to the ceiling. As a result, the boundary division between the outer edge portion of the lighting apparatus and the ceiling becomes not noticeable; therefore, a soft illumination can be achieved.

The lighting apparatus related to the present invention is provided with a power supply section supplying power to the light source that is provided at the central side of the lighting apparatus main body and a power supply cover covering the power supply section. The peripheral edge portion of the power supply cover is transparent to light.

The present invention is provided with the power supply section supplying power to the light source at the central side of the lighting apparatus main body and the power supply cover covering the power supply section. The peripheral edge portion of the power supply cover is transparent to light. The power supply section is arranged at the central portion of the lighting apparatus main body, therefore, the power supply section, the light source, wire connecting them and the like can be concentrated at the central side of the lighting apparatus main body so that moment acting on the lighting apparatus main body can be further reduced. Therefore, the deformation of the lighting apparatus main body can be prevented. A part of light emitted from the light source exits from the peripheral edge portion of the power supply cover, therefore, making the boundary division of the power supply cover less noticeable can be achieved.

With regard to the lighting apparatus related to the present invention, the light source includes a plurality of light source elements. At least one of the plurality of light source elements can be lighted up individually.

In the present invention, at least one of the plurality of light source elements can be lighted up individually, therefore, it is not necessary to set up a night-light for other purposes so that number of components can be reduced.

With regard to the lighting apparatus related to the present invention, the light source includes an LED.

In the present invention, an LED is used as the light source. Even if an LED with strong directivity is used, by providing the reflecting section, the light emitted from the LED is reflected in many directions so that a substantially uniform illumination with less illumination unevenness can be achieved.

According to the present invention, the deformation such as bending of the lighting apparatus main body can be prevented.

The above and further objects and features will more fully be apparent from the following detailed description with accompanying drawings.

### BRIEF DESCRIPTION OF THE DRAWING

FIG. 1 is a schematic outline perspective view of a lighting apparatus in accordance with Embodiment 1 of the present invention.

FIG. 2 is a schematic exploded perspective view of the lighting apparatus in accordance with Embodiment 1.

FIG. 3 is a schematic cross-sectional view of the lighting apparatus in accordance with Embodiment 1.

FIG. 4 is a schematic cross-sectional view of the central portion of the lighting apparatus in accordance with Embodiment 1.

FIG. 5 illustrates an arrangement of essential parts of the lighting apparatus in accordance with Embodiment 1.

FIG. 6 is a schematic view of an LED module of the lighting apparatus in accordance with Embodiment 1.

FIG. 7 is an explanation drawing of reflection of light emitted from the LED module in the lighting apparatus in accordance with Embodiment 1.

FIG. 8 is an explanation drawing of reflection of light emitted from the LED module in the lighting apparatus in accordance with Embodiment 1.

FIG. 9 is an explanation drawing of reflection of light emitted from the LED module in the lighting apparatus in accordance with Embodiment 1.

FIG. 10 is an explanation drawing of a night-light in the lighting apparatus in accordance with Embodiment 1.

FIG. 11 is a schematic cross-sectional view of a lighting apparatus in accordance with Embodiment 2 of the present invention.

FIG. 12 is a schematic local enlarged cross-sectional view of the lighting apparatus in accordance with Embodiment 2.

FIG. 13 is a schematic local enlarged cross-sectional view of a lighting apparatus in accordance with Embodiment 3.

FIG. 14 is a schematic local enlarged cross-sectional view of a lighting apparatus in accordance with Embodiment 4.

FIG. 15 is a schematic view illustrating an example of another applicable LED module in the present invention.

FIG. 16 is a schematic cross-sectional view of a lighting apparatus in accordance with Embodiment 5.

FIG. 17 is a schematic local enlarged cross-sectional view of the lighting apparatus in accordance with Embodiment 5.

FIG. 18 is a schematic perspective view of a lens to be used in the lighting apparatus in accordance with Embodiment 5.

FIG. 19 is a schematic cross-sectional view illustrating an example of another applicable lens in Embodiment 5.

FIG. 20A is an explanation drawing of protrusions provided at a reflection sheet.

FIG. 20B is an explanation drawing of protrusions provided at a reflection sheet.

FIG. 20C is an explanation drawing of protrusions provided at a reflection sheet.

FIG. 21 is a schematic cross-sectional view of a conventional lighting apparatus.

### DETAILED DESCRIPTION

An example of a detachable lighting apparatus (the so-called ceiling light) attached to an attaching body such as a suspended ceiling body disposed at an attaching member such as ceiling and the like based on drawings illustrating the embodiments of the present invention is described below in detail.

### Embodiment 1

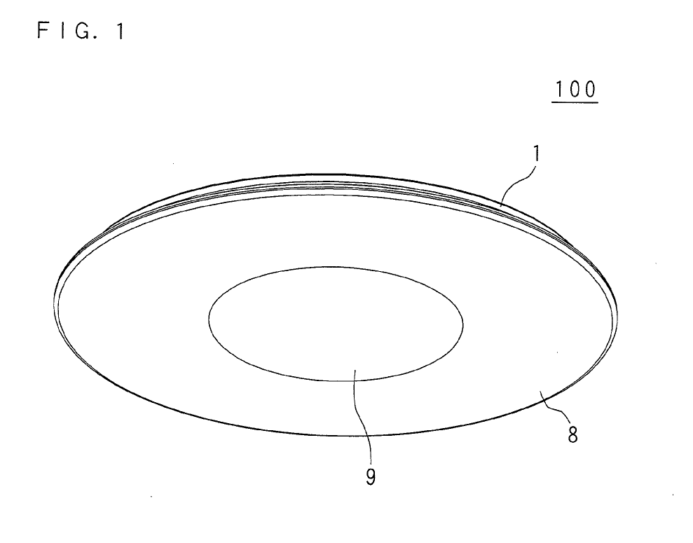

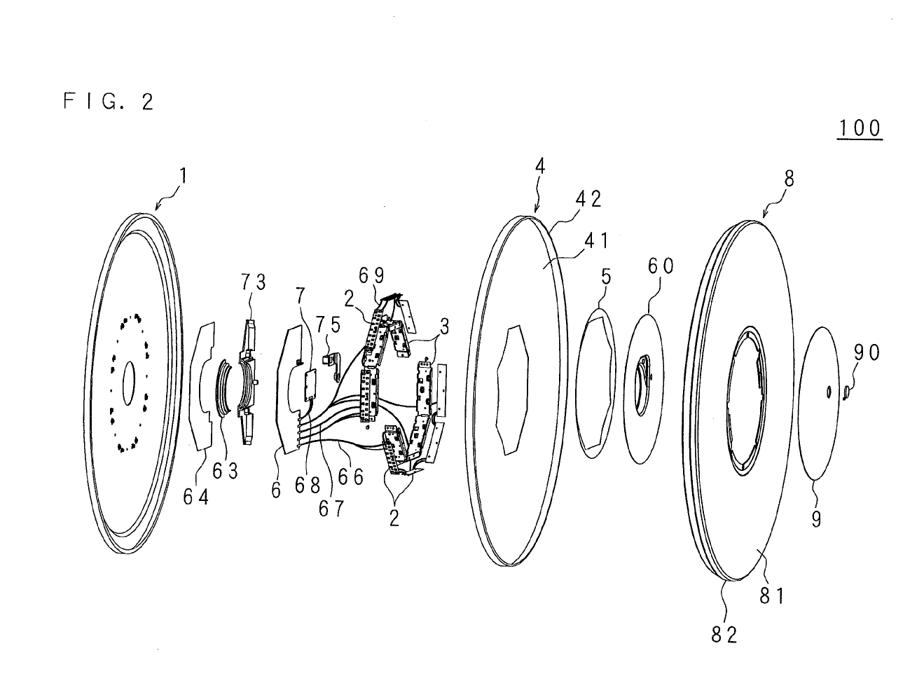

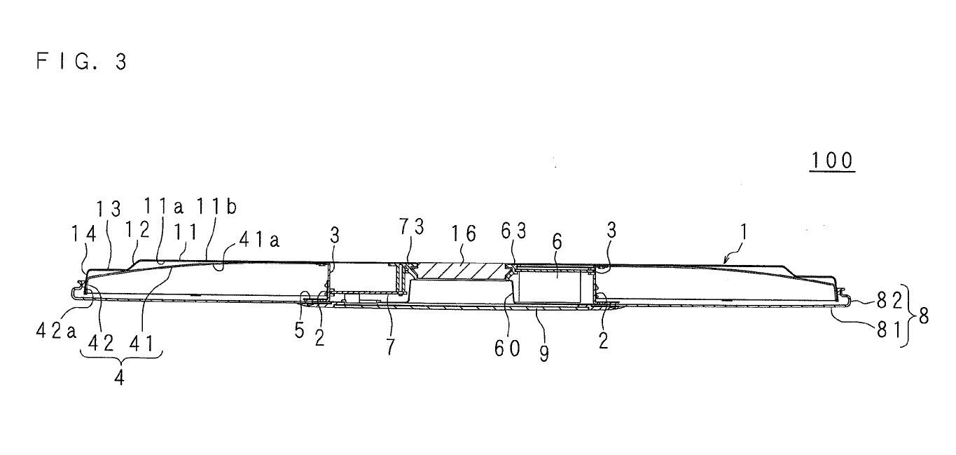

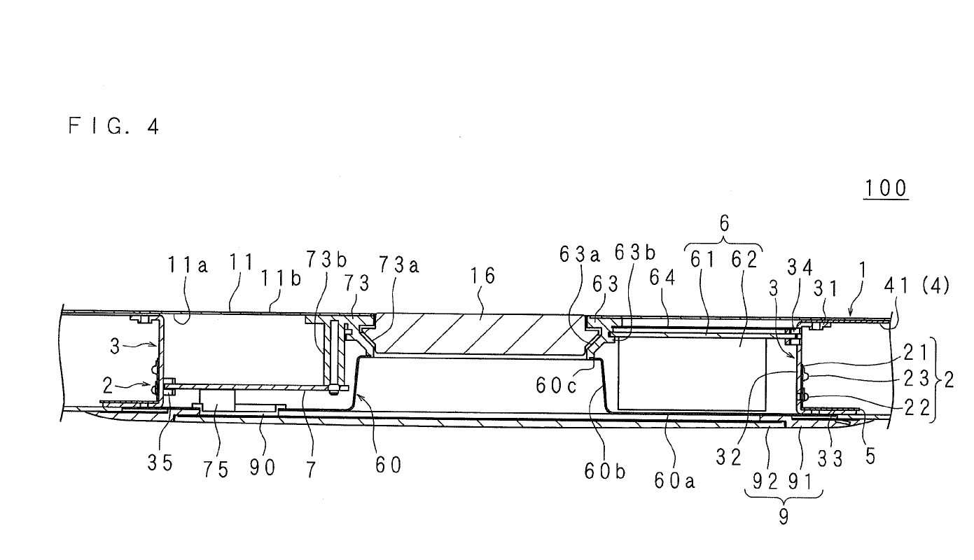

FIG. 1 is a schematic outline perspective view of a lighting apparatus 100 in accordance with Embodiment 1 of the present invention. FIG. 2 is a schematic exploded perspective view of the lighting apparatus 100 in accordance with Embodiment 1. FIG. 3 is a schematic cross-sectional view of the lighting apparatus 100 in accordance with FIG. 3. FIG. 4 is a schematic cross-sectional view of the central portion of the lighting apparatus in accordance with Embodiment 1, that is, a local enlarged view of FIG. 3.

Numeral reference 1 in figures is a chassis as a lighting apparatus main body for holding a light source and a reflecting section described below. The chassis 1 is provided with a disc base 11 having a circular blind hole at the center, a connecting section 12 connected to the outer edge portion of the base 11 in a crossing direction, an annular section 13 having a broad annular shape parallel to the base 11 and connected to the outer edge portion of the connecting section 12, and a peripheral wall 14 vertically arranged at the annular section 13. The chassis 1 forms a shallow bowl shape. The chassis 1 is made of a metal such as iron or aluminum. Moreover, the chassis 1 functions as a heat sink radiating heat generated in a heat radiator such as a light source.

An adaptor 16 is attached to the blind hole of the base 11 of the chassis 1. The adaptor 16 forms a flat cylindrical shape. The adaptor 16 is provided with a hook blade engaging to an engaging hole of an attaching body such as a suspended ceiling body and the like to be attached to an attaching member at one end side, and a connector connected to a power supply section. By engaging the hook blade to the engaging hole of the attaching body, the adaptor 16 is electrically and mechanically connected to the attaching body. The chassis 1 is attached to the adaptor 16 so that the adaptor 16 is connected and attached to the attaching body while the chassis 1 is attached to ceiling as an attaching member. The adaptor 16 is a well-known art; therefore, the detailed explanation is omitted.

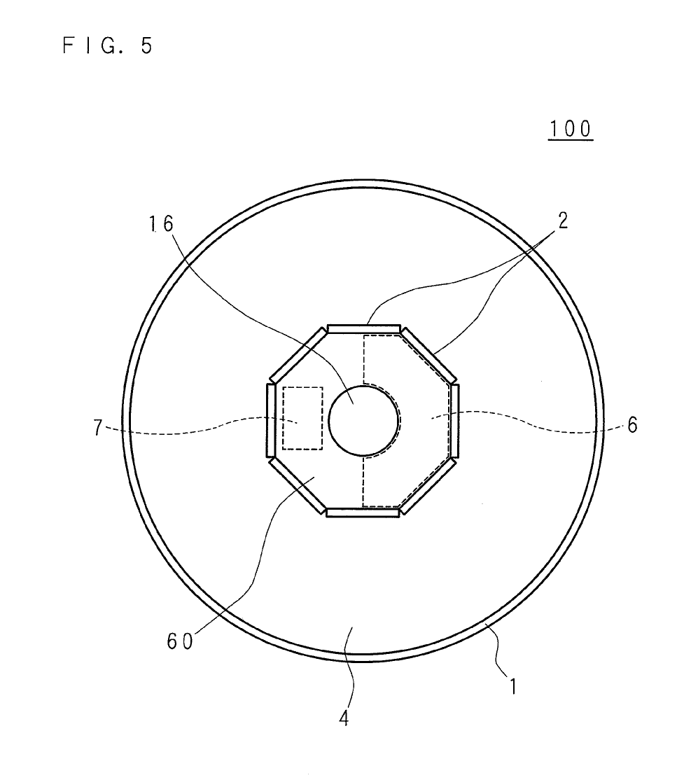

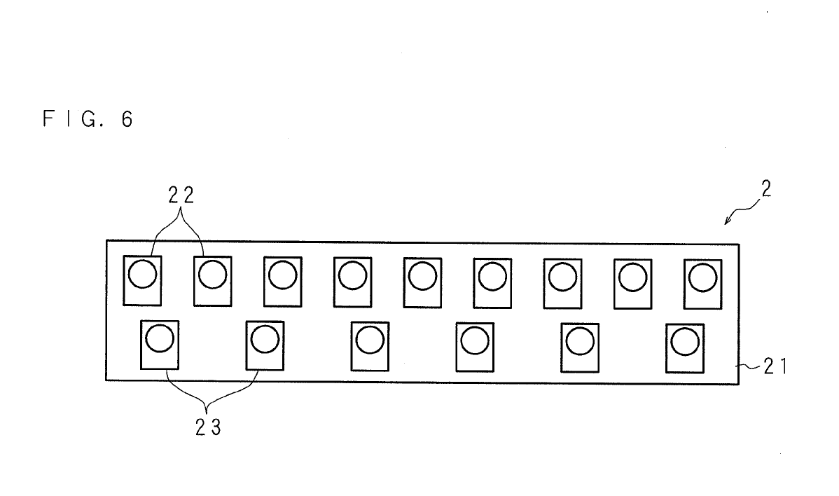

LED modules 2 as a light source are attached to one surface 11a (inner surface) of the base 11 of the chassis 1 such that the LED modules 2 surround the periphery of the adaptor 16 through a light source holding section 3 in a radial direction. FIG. 5 illustrates an arrangement of essential parts of the lighting apparatus 100 in accordance with Embodiment 1. FIG. 6 is a schematic view of the LED module 2 of the lighting apparatus 100 in accordance with Embodiment 1.

As shown in FIG. 6, the LED module 2 is provided with a rectangular plate shaped LED substrate 21, a plurality of daylight LEDs 22 emitting quasi-daylight serially mounted along the long side of the LED substrate 21, and a plurality of incandescent LEDs 23 emitting incandescent light serially mounted along the long side of the LED substrate 21 parallel to the daylight LEDs 22. The daylight LED 22 and the incandescent LED 23 are surface mount type LED including, for example, an LED element, a hemispherical sealing resin in which phosphors are scattered covering the LED element, an input terminal, and an output terminal. The daylight LED 22 and the incandescent LED 23 are mounted to the LED substrate 21 such that the optical axes of the daylight LED 22 and the incandescent LED 23 are substantially perpendicular to the LED substrate 21. The LED substrate 21 is made of a metal such as iron or aluminum, and it functions as a heat conductor conducting heat generated in the daylight LED 22 and the incandescent LED 23 to the light source holding section 3. Moreover, it is preferable that the LED substrate 21 is made of iron, because the coefficient of thermal expansion of iron is close to that of the resin of the daylight LED 22 and the incandescent LED 23.

In Embodiment 1, the daylight LEDs 22 are arranged on the LED substrate 21 such that the space between the neighboring daylight LEDs 22 is substantially the same. However, it is preferable that the space between the neighboring daylight LEDs 22 gradually becomes closer from the center of the long side of the LED substrate 21 towards the end. The arrangement of the incandescent LEDs 23 is also similar to that of the daylight LEDs 22. As similar to Embodiment 1, in a case where the plurality of LED modules 2 are arranged in multangular shape, increasing darkness at the boundary division between neighboring LED modules 2 can be prevented, the light from the LED module 2 exits uniformly in order that the difference of luminance does not occur corresponding to positions in peripheral direction. Moreover, in a case where the LED modules are arranged roundly on a flexible substrate and the like, it is preferable that the LED modules are arranged such that the space between neighboring LEDs is substantially the same as similar to Embodiment 1.

The U-shaped cross-sectional light source holding section 3 is provided with a rectangular holding plate 32 protruded from the one surface 11a of the base 11 and attached to the LED module 2, a fixing section 31 vertically arranged on one end of the long side of the holding plate 32 and fixed to the base 11 of the chassis 1, a holding section 33 provided at the other side of the long side of the holding plate 32 (the opposite side of the fixing section 31) with facing to the fixing section 31 in a parallel manner and holding a center cover as a power supply cover covering the later-mentioned power supply section, an engaging nail 34 holding a later-mentioned power supply substrate, and an engaging nail 35 holding a later-mentioned control substrate. The holding plate 32 is fixed to the non-mounting surface (the surface opposite to the mounting surface mounted by the daylight LED 22 and the incandescent LED 23) of the LED substrate 21 of the LED module 2 such that the long side of the LED substrate 21 corresponds to that of the holding plate 32 and that the daylight LED 22 is attached at the side of the holding section 33 (the farther side with respect to the reflection sheet 4 in the state of being attached to the chassis 1). The light source holding section 3 is made of a metal such as aluminum, it also functions as a heat conductor conducting heat generated in the LED module 2 as a heat radiator to the chassis 1 functioning as a heat sink.

The light source holding section 3 is substantially equally distributed at the base 11 of the chassis 1 in a circumferential direction and fixed to the fixing section 31 such that the surface of the holding plate 32 attached by the LED module 2 faces to the outer edge of the chassis 1, an octagonal peripheral wall is formed by the holding plates 32, and the directions of optical axes of the daylight LED 22 and the incandescent LED 23 face to the outer edge of the chassis 1. Moreover, the adjacent light source holding sections 3 are coupled and fixed by thread and the like. In this way, the light source holding section 3 is attached to the chassis 1, the LED module 2 is supported such that the LED substrate 21 crosses the chassis 1 at a substantially right angle in a radial direction and the directions of optical axes of the daylight LED 22 and incandescent LED 23 face to the outer edge portion of the chassis 1. As shown in FIG. 5, the LED modules 2 are arranged in an octagon shape on the chassis 1. When the LED module 2 is lighted up, the light emitted from the LED module 2 is radiated in a radial manner to the direction from the central portion of the base 11 of the chassis 1 to the outer edge portion.

Inside the chassis 1, the reflection sheet 4 as the reflecting section for reflecting light emitted from the LED module 2 is provided between the peripheral wall 14 and the light source holding section 3. The reflection sheet 4 is provided with a disc portion 41 having an octagonal hole corresponding to the arrangement shape of the LED module 2 at the center, and a peripheral wall 42 vertically arranged at the outer periphery of the disc portion 41. The disc portion 41 faces to the outer edge portion from the center, and the side of the one surface 41a is bended in a gradual manner that gradually forms concavity. The reflection sheet 4 is made of resin, and the processing is applied to the surface of the reflection sheet 4 for making diffused reflection easily. The convex side of the reflection sheet 4, that is, the surface at the opposite side of the one surface 41a is attached to the chassis 1 such that the surface is at the side of the chassis 1. In the condition of attaching, the peripheral wall 42 of the reflection sheet 4 is separated from the LED module 2 and opposite to the LED module 2; therefore, the inner circumferential surface 42a of the peripheral wall 42 is separated from the direction of light emission from the LED module 2, and becomes a reflection surface opposite to the direction of light emission from the LED module 2.

A top plate reflection sheet 5 as another reflecting section for reflecting light emitted from the LED module 2 to the side of the reflection sheet 4 is provided at the inner surface of the holding section 33 of the light source holding section 3. The top plate reflection sheet 5 is made of a disc-shaped resin having an octagonal hole matching to the arrangement shape of the LED module 2 at the center. The processing is applied to the surface of the top plate reflection sheet 5 for making diffused reflection easily. By fixing the top plate reflection sheet 5 to the inner surface of the holding section 33 of the light source holding section 3, the top plate reflection sheet 5 is attached to the opposite side of the reflection sheet 4 with respect to the LED module 2 and faces to the disc portion 41 of the reflection sheet 4.

A power supply section 6 is provided with a C-shaped power supply substrate 61 and electronic components 62 such as a rectifier circuit mounted to the power supply substrate 61 that rectifies current supplied from an alternator (AC generator), a transformer transforming the rectified potential into a predetermined potential. The power supply section 6 is provided through a power supply substrate supporting section 63 at the base 11 of the chassis 1 to be surrounded by the light source holding section 3. The power supply supporting section 63 forms a plane-viewed half ring shape and is attached to the peripheral edge portion of the attaching hole of the base 11 of the chassis 1. An engaging concavity 63a engaging to the adaptor 16 is formed on the inner surface of the power supply substrate supporting section 63. A clamp section 63b clamping the power supply substrate 61 of the power supply section 6 is provided on the outer surface of the power supply substrate supporting section 63. The base 11 of the chassis 1 supports the power supply section 6 in such a manner that the power supply substrate 61 is clamped by the engaging nail 34 of the light source holding section 3 and the clamp section 63 of the power supply substrate holding section 63. An insulation sheet 64 is supported by the light source holding section 3 and the power supply substrate supporting section 63 between the power supply section 6 and the base 11 of the chassis 1.

A rectangular plate shaped control substrate 7 is provided via a control substrate supporting section 73 at the opposite side of the power supply section 6 of the base 11 of the chassis 1 with respect to the adaptor 16 surrounded by the light source holding section 3. Electronic components (not shown) such as a control microcomputer, a dimmer control circuit are mounted on the control substrate 7. The control substrate supporting section 73 is provided with an engaging concavity 73a engaging to the adaptor 16 at the inner surface and a cylindrical supporting tube 73b supporting the control substrate 7 at the outer surface. The control substrate 7 is supported by the base 11 of the chassis 1 in such a manner that the control substrate 7 is supported by the engaging nail 35 of the light source holding section 3 and the supporting tube 73b of the control substrate supporting section 73. Moreover, a receiving section 75 receiving a signal from a remote controller is attached to the control substrate 7.

As described above, the power supply section 6 and the control substrate 7 are attached to the power supply substrate holding section 63, the control substrate holding section 73 and the coupled light source holding section 3 such that an octagonal peripheral wall is formed, therefore, the LED module 2, the power supply section 6 and the control substrate 7 can be formed in an integrated manner so that it is possible that the integrated unit can be formed as a compact unit.

The power supply section 6 is electrically connected through wires 66, 67 to the LED module 2. A wire 69 as a jumper cable is used for electrical connection between the LED modules. The power supply section 6 is electrically connected through a wire 68 to the control substrate 7.

The power supply section 6 and the control substrate 7 are housed in a cavity to be formed by the base 11 of the chassis 1 and the light source holding section 3, and the cavity is sealed by a substrate cover 60. The substrate cover 60 is provided with a disc-shaped cover 60a having a circular hole at the center, a peripheral wall 60b vertically arranged at the inner edge portion of the cover 60a, and an annular section 60c being parallel and connected to the cover 60a from the opposite side of the cover 60a of the peripheral wall 60b. The annular section 60c is carried on the power supply substrate supporting section 63 and the control substrate supporting section 73, the outer edge portion of the cover 60a is fixed to the holding section 33 of the light source holding section 3 by a thread and the like.

As described above, the LED module 2, the power supply section 6, the control substrate 7 and the substrate cover 60 are attached to the chassis 1. The chassis 1 is provided with a ring cover 8 having light diffusion properties covering the LED module 2 and the reflection sheet 4. The ring cover 8 is provided with a disc-shaped annular section 81 having a circular hole at the center and a peripheral wall 82 vertically provided on the outer peripheral edge of the annular section 81. The ring cover 8 is attached to the peripheral wall 14 of the chassis 1 at the peripheral wall 82. The LED module 2 as the light source is housed in the cavity to be formed by the ring cover 8, the light source holding section 3 and the chassis 1 so that only the LED module 2 can be sealed.

A demountable center cover 9 as a disc-shaped power supply cover is attached to the inner peripheral edge portion of the annular section 81 of the ring cover 8. The center cover 9 is provided with a ring-shaped light penetrating section 91 and a non-light permeable cover 92 provided at the inner peripheral edge of the light penetrating section 91. Moreover, a circular hole for receiving the signal transmitted from a remote controller is provided at the cover 92, and a cover 90 is fitted to the circular hole.

The lighting apparatus main body, which is assembled as described above, is attached to the adaptor 16 such that the side of the one other surface lib of the base 11 of the chassis 1 is at the side of the attaching member, after the connector of the adaptor 16 is connected to the connector connected to the power supply section 6, the center cover 9 is attached to the lighting apparatus main body. The attachment and removal from the attaching member such as the ceiling of the lighting apparatus main body can be performed by the removal of the center cover 9. The sealing of the section of the light source is to be kept because it is not necessary to remove the ring cover 8 and the like.

With regard to the lighting apparatus 100 related to Embodiment 1, the LED module 2 is not arranged at the outer edge portion of the chassis 1 (lighting apparatus main body), therefore, the distance to the LED module 2 from the center of the chassis 1 as the attachment site to be attached at the attaching member such as ceiling can be shortened. Comparing to a case where the LED module 2 is arranged at the outer edge portion of the chassis 1, the moment acting on the chassis 1 can be reduced. Therefore, the deformation of the chassis 1 can be prevented and hence the reliability of the lighting apparatus 100 can be improved. The power supply section 6 is arranged at the central portion of the chassis 1, therefore, the power supply section 6 and the wires connecting the power supply section 6 and the LED module 2 can be concentrated at the side of the central portion of the chassis 1 so that the moment acting on the chassis 1 can be further reduced, the deformation of the chassis 1 is prevented and hence the reliability of the lighting apparatus 100 can be improved.

In the lighting apparatus 100 attached to the attaching member, the power supply section 6 is connected to an AC generator through the adaptor 16 and the attaching member such as the suspended ceiling body. In this status, when the power supply is on, an AC current is supplied to the power supply section 6, and then a power of a predetermined potential and current is supplied from the power supply section 6 to the LED module 2 and hence the LED module 2 having the daylight LED 22 and the incandescent LED 23 is lighted up.

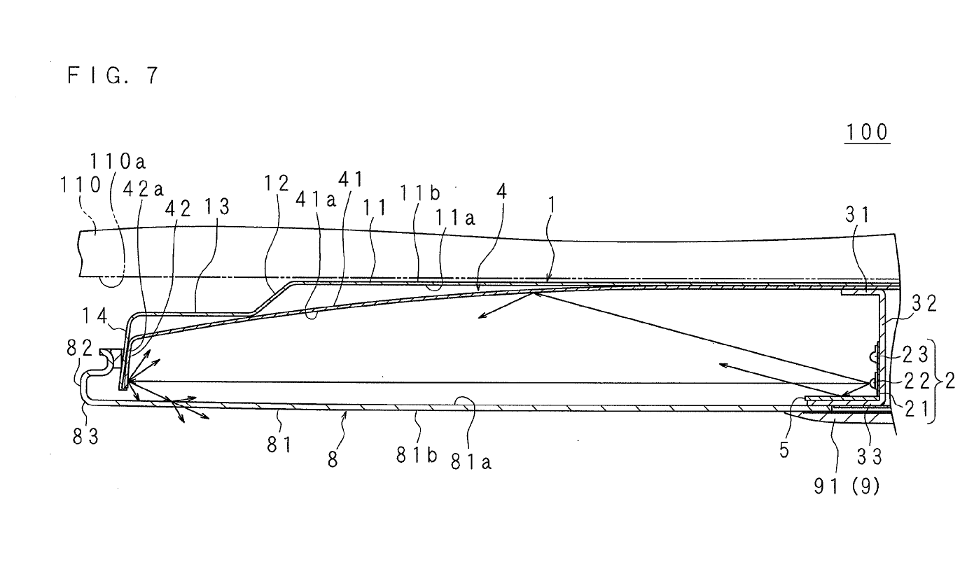

In the lighting apparatus 100, the light emitted from the LED module 2 is radiated in the direction towards the outer edge portion from the central portion of the lighting apparatus 100. In other words, the light is radiated in the direction towards the outer edge portion from the central portion of the chassis 1, and then the incoming light at the reflection sheet 4 or the top plate reflection sheet 5 is reflected on the reflection sheet 4 or the top plate reflection sheet 5, the light is mainly radiated in the direction crossing the direction of light emission from the LED module 2 (direction crossing a ceiling surface 10a of a ceiling 110). FIGS. 7 to 9 are explanation drawings of reflection of the light emitted from the LED module 2 in the lighting apparatus 100 related to Embodiment 1.

As indicated by the arrows in FIG. 7, a part of the light emitted from the LED module 2 is mirror-reflected on the one surface 41a of the disc section 41 of the reflection sheet 4. The other part of the light emitted from the LED module 2 is incident in a substantially right angle on the inner circumferential surface 42a of the peripheral wall 42 of the reflection sheet 4 which is opposite and separated from the direction of light emission from the LED module 2, and then the light is reflected irregularly on the inner circumferential surface 42a, in other words, the light is reflected in many directions. A part of the light diffused at the inner circumferential surface 42a of the peripheral wall 42 of the reflection sheet 4 is incident on the one surface 41a of the reflection sheet 4 and further reflected on the one surface 41a. The other part of light is incident on the inner surface 81a of the ring cover 8 without being incident on the reflection sheet 4, and then the light is diffused inside the ring cover 8 and radiated to outside of the lighting apparatus 100 from the outer surface 81b of the ring cover 8.

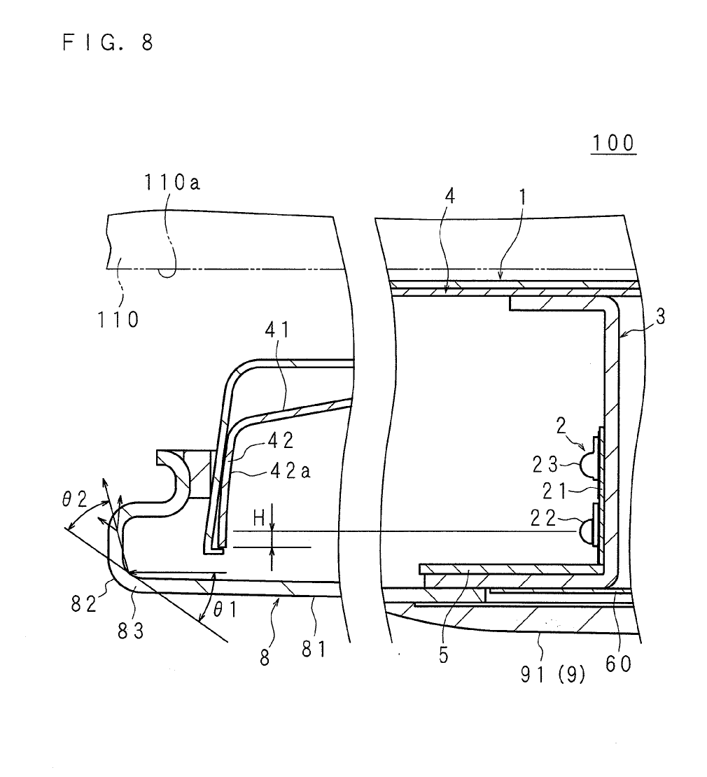

As shown in FIG. 8, the peripheral wall 42 of the reflection sheet 4 is taller than the optical axis of the daylight LED 22 of the LED module 2 by a predetermined height (H). The predetermined height (H) is appropriately set, corresponding to the light distribution properties of the LED module 2, so that the light is sufficiently radiated from the lighting apparatus 100 towards the direction (indoor living space) crossing the ceiling surface 110a

As described above, the radiating direction of the lighting apparatus 100 is a direction crossing the direction of light emission from the LED module 2, while the direction of light emission from the LED module 2 is the direction from the central portion of the lighting apparatus 100 to the outer edge portion thereof, in other words, the direction of light emission from the LED module 2 is the direction from the central portion of the chassis 1 to the outer edge portion thereof. Therefore, a part of the light emitted from the LED module 2 directly incident on the ring cover 8 and then exiting to outside of the lighting apparatus 100 can be reduced. Therefore, the direct light emitted from the LED module 2 entering to a user's eyes can be reduced and hence the glare can be reduced.

In a case where reflection members such as the reflection sheet 4, the top plate reflection sheet 5 and the like are not provided, it gradually becomes darker from the central portion towards the outer edge portion in the lighting apparatus. However, as the reflection sheet 4 is provided in Embodiment 1, the light emitted from the LED module 2 can be reflected on the reflection sheet 4 in many directions. Therefore, the outer edge portion and central portion of the lighting apparatus 100 become brighter and hence a substantially uniform illumination with less illumination unevenness can be achieved.

Additionally, a part of the light emitted from the LED module 2, as indicated by the arrows in FIG. 7, is reflected on the top plate reflection sheet 5. Therefore, the direct light emitted from the LED module 2 exiting to outside of the lighting apparatus 100 from the vicinity of the LED module 2 can be prevented and hence the glare can be further reduced. Thus, the light intensity (low/high) corresponds to the distance (long/short) from the LED module 2. The direct light emitted from the LED module 2 exiting to outside of the lighting apparatus 100 from the vicinity of the LED module 2 is prevented so that the light with high intensity can be prevented from exiting to outside of the lighting apparatus 100. The illumination unevenness is further reduced, and a substantially uniform illumination can be achieved.

In Embodiment 1, the daylight LED 22 as the light source element with high color temperature is arranged at the farther side from the reflection sheet 4 than the incandescent LED 23 as the light source element with low color temperature, therefore, the light emitted from the daylight LED 22, which is more eye-catching than the light emitted from the incandescent LED 23, is reflected on the reflection sheet 4 at the vicinity of the LED module 2 so that the amount of light exiting to outside of the lighting apparatus 100 can be reduced. The light emitted from the daylight LED 22 with strong light intensity to be radiated can be reduced. Therefore, the glare can further be reduced so that the illumination unevenness is further reduced and then the a substantially uniform illumination can be achieved.

As shown in FIG. 8, the space (gap) through which the light passes is provided between the end part of the side of the outer edge portion of the reflection sheet 4 and the ring cover 8 in Embodiment 1. Embodiment 1 provides an inclined portion 83 inclined towards the reflection sheet 4 in such a manner that the inclined portion 83 forms an angle as a predetermined angle θ1 with the optical axis of the daylight LED 22, at the outer edge portion of the light diffusible ring cover 8 with light diffusion characteristics covering the LED module 2 and the reflection sheet 4, in detail, at the coupling section between the annular section of the ring cover 8 and the peripheral wall 82 vertically arranged on the outer periphery of the annular section 81. Moreover, the predetermined angle θ1 is approximately set so that the light from the LED module 2 incident on the inclined portion 83 is mirror-reflected (θ2=θ1), for example, setting the angle to 30°. A part of the light emitted from the LED module 2 is mirror-reflected on the inclined portion 83 of the ring cover 8 and then the light is radiated towards the ceiling surface 110a of the ceiling 110. As a result, the boundary division between the outer edge portion of the lighting apparatus 100 and the ceiling 110 becomes not noticeable and hence the soft illumination can be achieved. Moreover, the inclined portion 83 may be bended as described in Embodiment 1. Alternatively, the inclined portion 83 may also be an inclined plane.

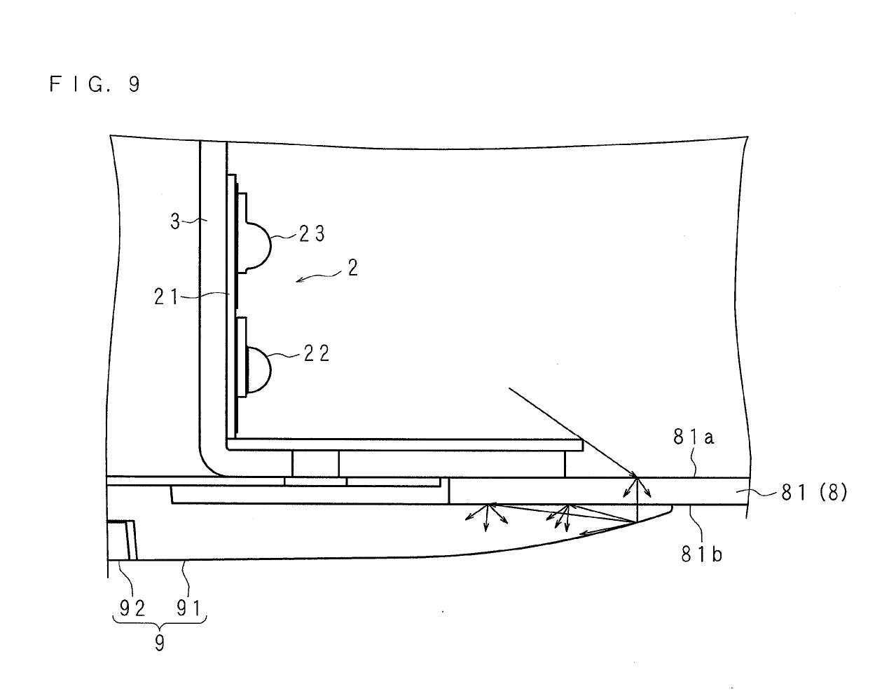

In Embodiment 1, the periphery of the center cover 9 as a power supply cover covering the power supply section 6 provided at the central portion of the chassis 1 is referred as an annular light transmitting section 91. The outer diameter of the light transmitting section 91 of the center cover 9 becomes larger than that of the top plate reflection sheet 5. A part of the light emitted from the LED module 2, as indicated in FIG. 9, is incident on the light transmitting section 91 as the periphery of the center cover 9 in a state where the incident angle is large, and then the light is diffused on the light transmitting section 91, in other words, the light is reflected in many directions. A part of the light, which is diffused on the light transmitting section 91, is further reflected on the ring cover 8 and exits to outside of the lighting apparatus 100. In this way, a part of the light emitted from the LED module 2 is radiated in many directions at the periphery of the center cover 9 and hence the boundary division between the center cover 9 and the ring cover 8 becomes not noticeable.

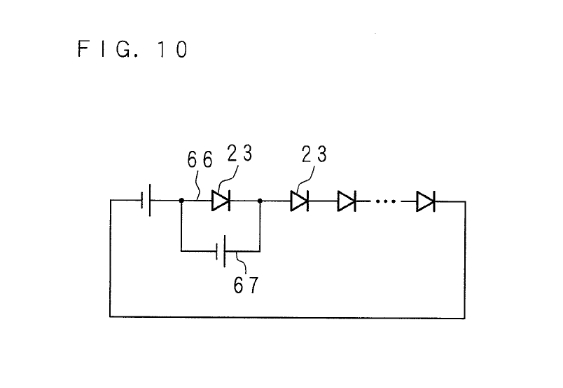

In Embodiment 1, at least one LED among the daylight LEDs 22 and the incandescent LEDs 23 of the LED module 2 can be independently lighted up and is possible to be configured as a night-light. FIG. 10 is an explanation drawing of a night-light in the lighting apparatus in Embodiment 1 as a schematic circuit diagram of a specified incandescent LED 23 of the LED module 2. An array of LEDs is connected in series by the plurality of incandescent LED 23. As shown in FIG. 10, the power is supplied to the array of LEDs by the power supply section 6 through the wire 66, however, it is possible to provide the power supplied by the power supply section 6 through the wire 67 individually to one of the plurality of incandescent LED 23. In this way, at least one of the incandescent LED 23 can be lighted up so that it is not necessary to provide a night-light for other purposes and hence the number of components can be reduced.

In Embodiment 1, the incandescent LED 23 installed in the plurality of LED module 2 can be lighted up individually. The plurality of incandescent LEDs 23 are used as night-lights, however, one night-light may also be used. Additionally, the incandescent LED 23 is used as the night-light, however, the daylight LED 22 may also be used as the night-light or both of the daylight LED 22 and the incandescent LED 23 may also be used as the night-light.

In Embodiment 1, an LED is used as the light source. Even if an LED with strong directivity is provided in the lighting apparatus, the above-mentioned reflection sheet 4 is provided in the lighting apparatus so that the light emitted from the LED module 2 is reflected in many directions and hence a substantially uniform illumination with less illumination unevenness can be achieved.

### Embodiment 2

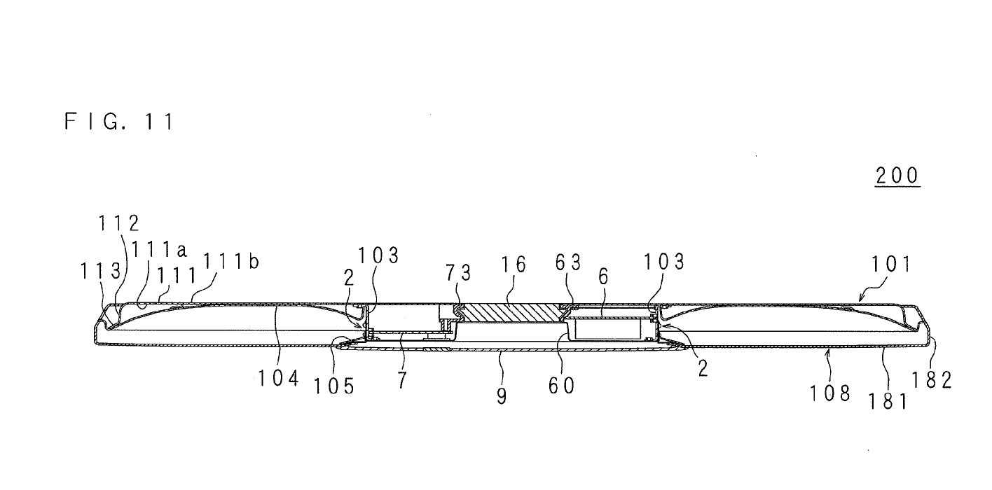

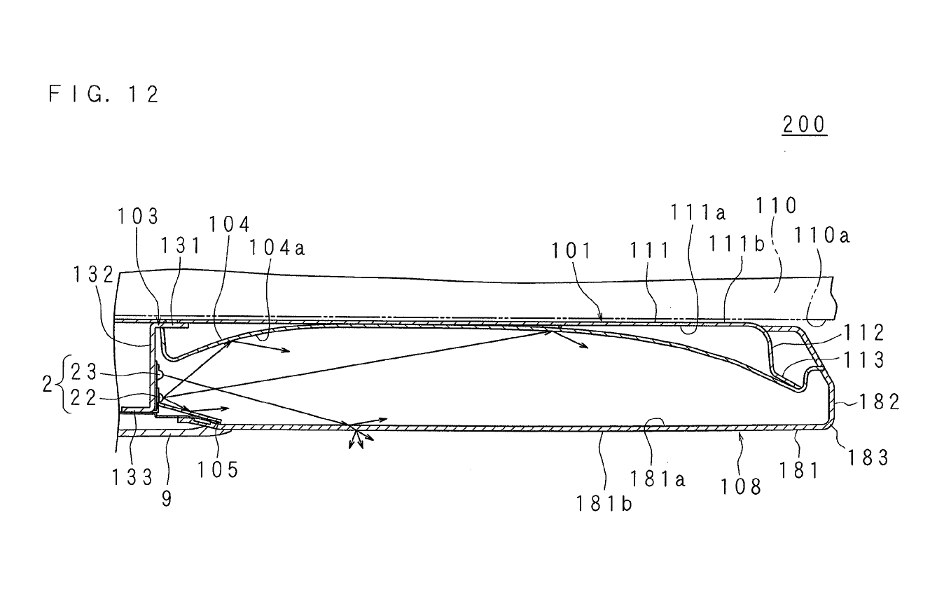

FIG. 11 is a schematic cross-sectional view of a lighting apparatus 200 related to Embodiment 2 of the present invention. FIG. 12 is a local schematic enlarged cross-sectional view of the lighting apparatus 200 of Embodiment 2, in other words, an explanation drawing of the reflection of light emitted from the LED module 2 in the lighting apparatus 200 related to Embodiment 2. The shape of a reflection sheet 104 in Embodiment 2 is different from Embodiment 1. The shapes of a top plate reflection sheet 105, a chassis 101 and a ring cover 108 vary with respect to the shape of the reflection sheet 104.

The chassis 101 is provided with a disc-shaped base 111 having circular hole at the center, a connecting section 112 connected to the outer edge portion of the base 111 in the crossing direction, and an annular holding section 113 holding the reflection sheet 104 that is connected to the outer edge portion of the connecting section 112 in the crossing direction. The chassis 101 roughly forms a shallow-bowl shape. The chassis 101 is made of metal such as iron or aluminum. Moreover, the chassis 101 also functions as a heat sink for radiating heat generated in a heat radiator such as a light source.

The disc-shaped reflection sheet 104 has an octagonal hole matching to the arrangement shape of the LED module 2 at the center, and the reflection sheet 104 is bended such that the side of one surface 104a becomes concave. More specifically, the one surface 104a as a reflection surface is inclined towards the side of the outer edge portion in a gradual manner from the central portion to the middle portion between the central portion and the outer edge portion, has a plane shape at the middle portion, and is inclined towards the side of the central portion in a gradual manner from the middle portion to the outer edge portion. The reflection sheet 104 is made of resin, and processing is applied to the surface for making diffused reflection easily. The convex side of the reflection sheet 104, that is, the surface at the opposite side of the one surface 104a is attached to the chassis 1 such that the surface is at the side of the chassis 1.

The top plate reflection sheet 105 is made of disc-shaped resin having an octagonal hole matching to the arrangement shape of the LED module 2 at the center, processing is applied to the surface for making diffused reflection easily. With regard to the top plate reflection sheet 105, the reflection surface is inclined to the outward direction such that the side of the reflection surface becomes concave.

The ring cover 108 is provided with a disc-shaped annular section 181 having a circular hole at the center and a peripheral wall 182 vertically arranged on the outer periphery of the annular section 181. The ring cover 108 is attached to the chassis 101 at the peripheral wall 182. Other elements identical to those described above with reference to Embodiment 1 illustrated in FIGS. 3 and 7 are designated with the same reference numerals and a detailed description thereof is omitted herein.

Even in the lighting apparatus 200 related to Embodiment 2 configured as described above, the LED module 2 is not arranged at the outer edge portion of the chassis 101 (the lighting apparatus main body), therefore, as similar to the lighting apparatus 100 related to Embodiment 1, the moment acting on the chassis 101 can be reduced. Therefore, the deformation of the chassis 101 is prevented and hence the reliability of the lighting apparatus 200 can be improved.

In the lighting apparatus 200 related to Embodiment 2, a part of the light emitted from the LED module 2, as shown by the arrows in FIG. 12, is mirror-reflected on the one surface 104a of the reflection sheet 104. Other part of the light emitted from the LED module 2 is incident on an inner surface 181a of the ring cover 108 without being incident on the reflection sheet 104, and then the light is diffused inside the ring cover 108 and exits to outside of the lighting apparatus 200 from an outer surface 181b of the ring cover 108. Moreover, a part of the light emitted from the LED module 2, as indicated by the arrows in FIG. 12, is reflected on the top plate reflection sheet 105.

Even in the lighting apparatus 200 related to Embodiment 2, the radiating direction of the lighting apparatus 200 is a direction crossing the direction of light emission from the LED module 2, while the direction of light emission from the LED module 2 is the direction from the central portion of the lighting apparatus 200 to the outer edge portion thereof, in other words, the direction of light emission from the LED module 2 is the direction from the central portion of the chassis 101 to the outer edge portion. Therefore, the glare can be reduced as similar in the lighting apparatus 100 related to Embodiment 1.

Even in the lighting apparatus 200 related to Embodiment 2, the light emitted from the LED module 2 can be reflected on the reflection sheet 4 in many directions so that the outer edge portion and central portion of the lighting apparatus 200 can be brighter and hence a substantially uniform illumination with less illumination unevenness can be achieved as similar in Embodiment 1.

Thus, as similar to the lighting apparatus 100 in Embodiment 1, the direct light emitted from the LED module 2 exiting to outside of the lighting apparatus 200 from the vicinity of the LED module 2 can be prevented by providing the top plate reflection sheet 105 so that the glare and illumination unevenness can be further reduced and hence a substantially uniform illumination can be achieved.

### Embodiment 3

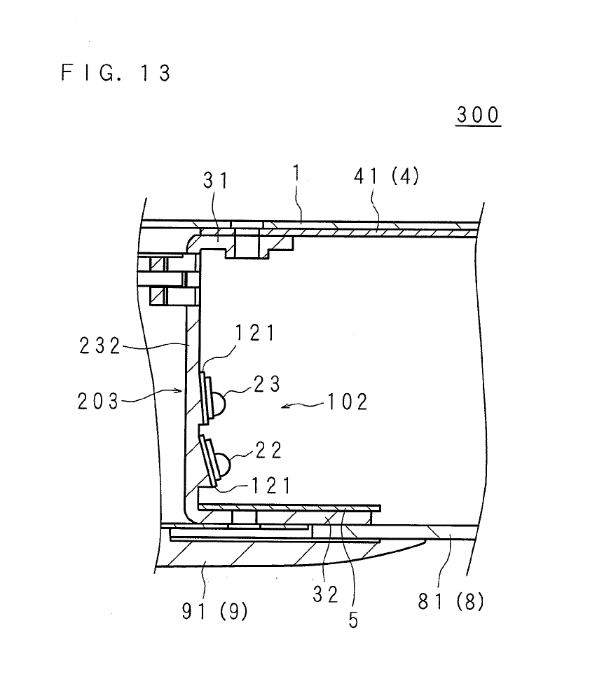

FIG. 13 is a schematic local enlarged cross-sectional view of a lighting apparatus 300 related to Embodiment 3. In Embodiment 3, LED substrates 121 are provided to a daylight LED 22 and an incandescent LED 23 separately, these LED substrates 121 are inclined and attached to a holding plate 232 of a light source holding section 203. The daylight LED 22 is more inclined towards the reflection sheet 4 than the incandescent LED 23. Other elements identical to those described above with reference to Embodiment 1 shown in FIG. 3 are designated with the same reference numerals and a detailed description thereof is omitted herein.

In the lighting apparatus 300 related to Embodiment 3, the LED substrates 121 on which the daylight LED 22 and the incandescent LED 23 of the LED module 102 are mounted are inclined towards the reflection sheet 4 so that the middle portion between the central portion and the outer edge portion of the lighting apparatus 300 as well as the outer edge portion can be brighter and so that a substantially uniform illumination can be achieved as similar in the Embodiment 1. Moreover, in Embodiment 3, the daylight LED 22 is more inclined towards the reflection sheet 4 than the incandescent LED 23, however, it is not limited to this case. The inclined angles of the daylight LED 22 and the incandescent LED 23 may be the same or opposite.

Thus, even in the lighting apparatus 300 related to Embodiment 3, the LED module 102 is not arranged on the outer edge portion of the chassis 1 (the lighting apparatus main body), therefore, the moment acting on the chassis 1 can be reduced so that the deformation of the chassis 1 is prevented and hence the reliability of the lighting apparatus 300 can be improved.

### Embodiment 4

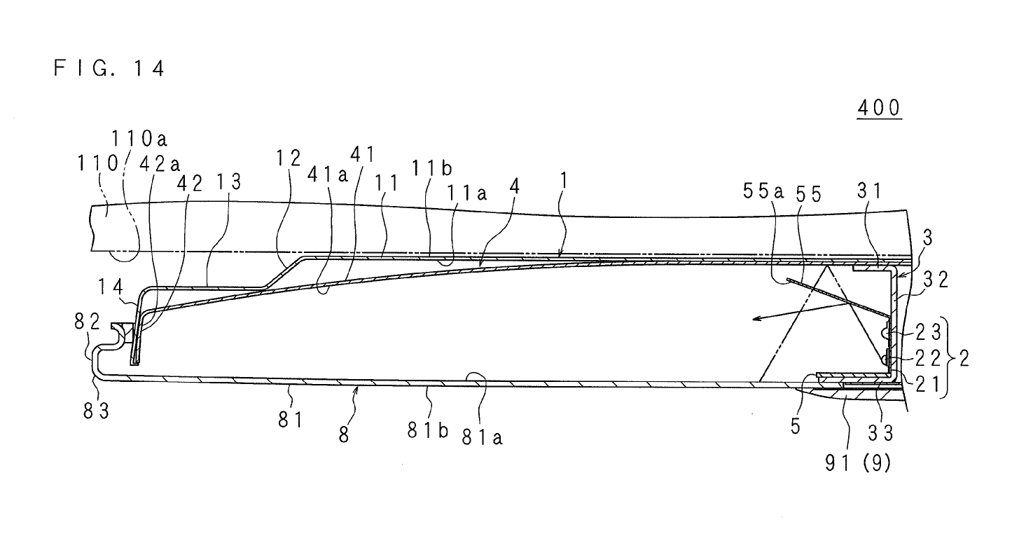

FIG. 14 is a schematic local enlarged cross-sectional view of the lighting apparatus 400 related to Embodiment 4. The lighting apparatus 400 related to Embodiment 4 is configured by adding a mirror reflection member 55 for mirror-reflecting the light emitted from the LED module 2 in the lighting apparatus 100 in Embodiment 1.

The mirror reflection member 55 is attached to a light source holding section 3. The mirror reflection member 55 forms a plated member in a conical shape having an octagonal shape at the center, and one surface 55a is inclined outwardly such that the side of the one surface 55a as the reflection surface becomes convex. The mirror reflection member 55 is fixed to a holding plate 32 of the light source holding section 3 along the long side to which an incandescent LED 23 of the LED module 2 is mounted (the long side and opposite side to which a top plate reflection sheet 5 is attached) such that the side of the one surface 55a is at the side of the LED module 2. The mirror reflection member 55 is not limited to the mirror, a member capable of performing mirror reflection may also be used. Other elements identical to those described above with reference to Embodiment 1 illustrated in FIG. 7 are designated with the same reference numerals and a detailed description thereof is omitted herein.

In the lighting apparatus 400 related to Embodiment 4, a part of the light emitted from the LED module 2 exits towards the chassis 1 at the vicinity of the LED module 2, as indicated by the arrows in FIG. 14, the light is mirror-reflected on the one surface 55a of the mirror reflection member 55, and then the light exits to the outer edge portion of the lighting apparatus 400. In a case where the mirror reflection member 55 is not provided, a part of the light exiting to the chassis 1 at the vicinity of the LED module 2, as indicated by the two-dotted line in FIG. 14, is reflected on the chassis 1, and then the light is incident on a ring cover 8 at the vicinity of the LED module 2 and diffused inside the ring cover 8 while the light is exiting to outside of the lighting apparatus 400. The light intensity (low/high) corresponds to the distance from the LED module 2 (long/short) as described above. Therefore, in a case where the mirror reflection member 55 is not provided, the light with high intensity is included in the light radiated from the vicinity of the LED module 2 to outside of the lighting apparatus 400. As the mirror reflection member 55 is provided, however, the light with high intensity can be reflected towards the outer edge portion of the lighting apparatus 400.

In Embodiment 4, the light with high intensity exiting to outside of the lighting apparatus 400 from the vicinity of the LED module 2 can further be prevented along with the effects achieved in the configuration of the lighting apparatus 100 related to Embodiment 1.

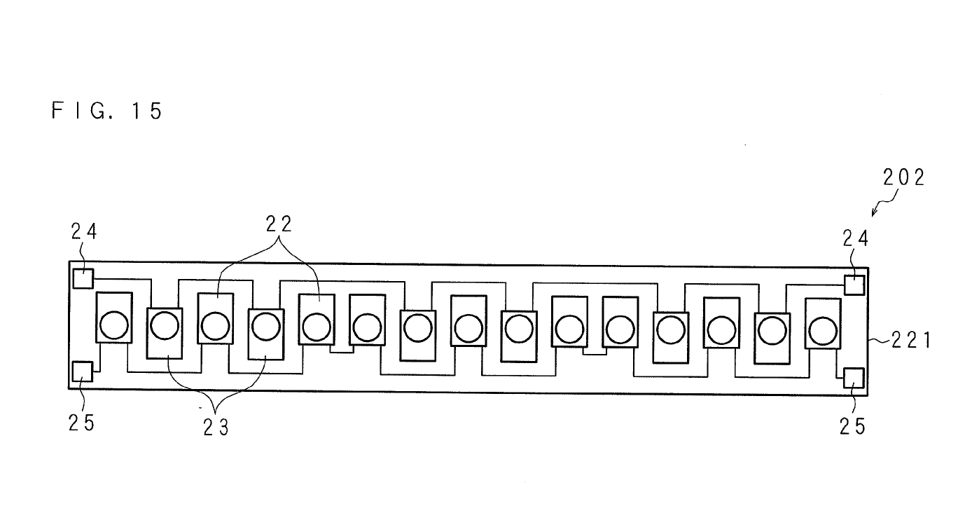

In Embodiments 1 to 4, the LED module 2 in which light source elements with different color temperatures (the daylight LED 22 and the incandescent LED 23) are arranged in parallel is used as shown in FIG. 6, however, an applicable LED module is not limited to this case. For example, light source elements with different color temperatures may be arranged on a substantially straight line. FIG. 15 is a schematic view illustrating an example of another applicable LED module 202 in the present invention.

As shown in FIG. 15, the LED module 202 is provided with a rectangular plated LED substrate 221, a plurality of daylight LEDs 22 mounted on the LED substrate 221 along the long side in series that emit the light with daylight color, and a plurality of incandescent LEDs 23 mounted between daylight LEDs 22 that emit the light with incandescent color. The LED module 202 is different from the LED module 2, and the light emitting sections (the parts of an LED element and sealing resin noted as circles in the figure) of the daylight LED 22 and the incandescent LED 23 are at the inner side. The daylight LED 22 and the incandescent LED 23 are arranged alternately such that the light emitting sections of the daylight LEDs 22 and the incandescent LEDs 23 are arranged on a substantially straight line.

A first connecting section 25 is arranged on both ends of a circuit pattern for power supply in which the plurality of daylight LEDs 22 are connected in series. Similarly, a second connecting section 24 is arranged on both ends of a circuit pattern for power supply in which the plurality of incandescent LEDs 23 are connected in series. Moreover, with regard to the connection between the plurality of LED modules 202, these first connecting section 25 and second connecting section 24 are connected to each other by wires 69 as jumper cables.

The light emitting sections of the daylight LEDs 22 and the incandescent LEDs 23 are arranged on a substantially straight line in the LED module 202. As compared to a case where the daylight LEDs 22 and the incandescent LEDs 23 are arranged in parallel, it is easy to optimally design reflection members such as a reflection sheet, top plate reflection sheet, mirror reflection member and the like. Therefore, a substantially uniform illumination with less illumination unevenness can be achieved.

Moreover, the daylight LED 22 and the incandescent LED 23 are mounted on the LED substrate 221 such that the sides of the light emitting sections are at the inner side of the substrate. Therefore, as shown in FIG. 15, the wire bypassing other LEDs and forming a circuit pattern without elongating the wire length can be achieved and hence the interconnection becomes easier.

### Embodiment 5

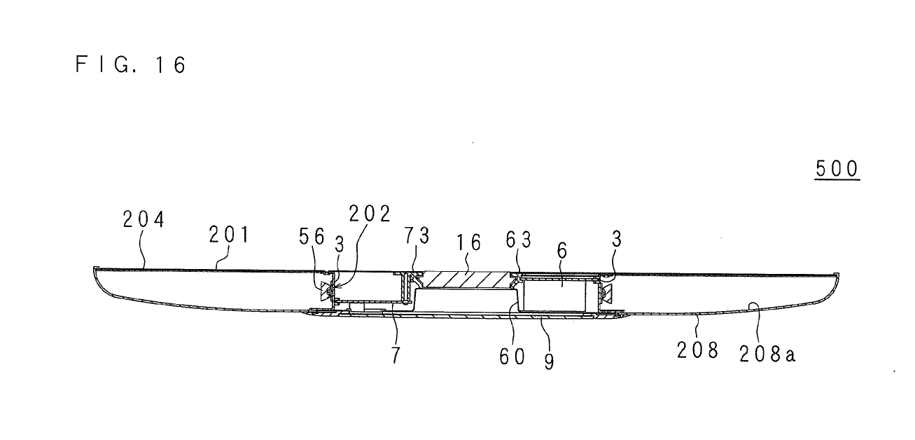

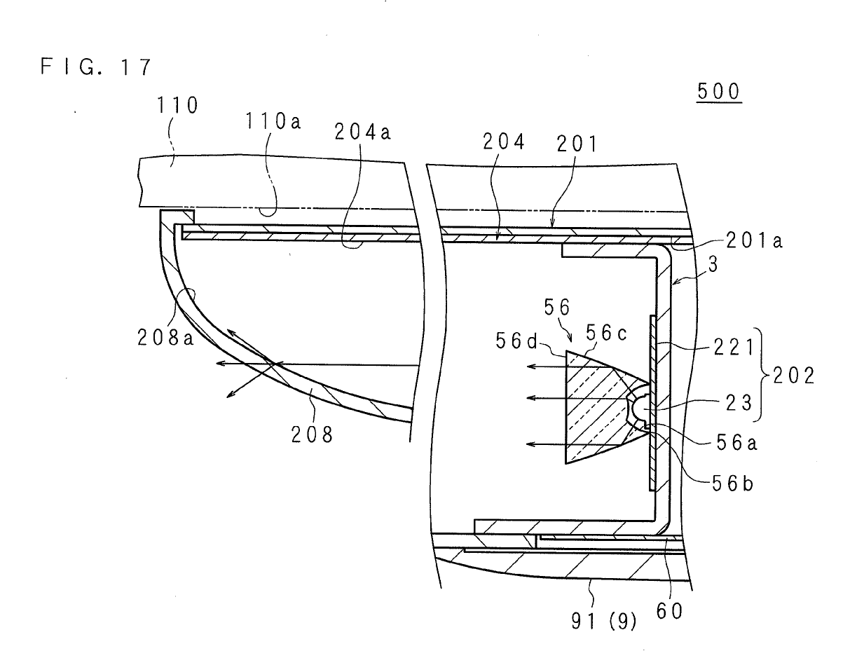

FIG. 16 is a schematic cross-sectional view of a lighting apparatus 500 related to Embodiment 5. FIG. 17 is a schematic local enlarged view of the lighting apparatus 500 related to Embodiment 5. The present Embodiment 5 is different from Embodiments 1 to 4. In addition to a reflection member such as a reflection sheet, a lens is used in the present Embodiment 5.

A chassis 201 holding a light source and a reflecting section forms a disc shape having a circular hole at the center. The chassis 201 is made of metal such as iron or aluminum. The chassis 201 also functions as a heat sink for radiating heat generated in a heat radiator such as a light source.

An LED module 202 is attached to one surface 201a of the chassis 201 through a light source holding section 3 to surround the periphery of an adaptor 16 in a radial direction. The LED module 202 in Embodiment 5 is the same as the LED module 202 illustrated in FIG. 15 in Embodiment 4, therefore, the detailed description is omitted.

A reflection sheet 204 as the reflecting section for reflecting the light emitted from the LED module 202 is provided at the chassis 201. The reflection sheet 204 is made of resin forming a disc shape that has an octagonal hole matching to the arrangement shape of the LED module 202 at the center, and processing is applied to one surface 204a for making diffused reflection easily. The reflection sheet 204 is attached to one surface 201a of the chassis 201 such that the surface at the opposite side of the one surface 204a is at the side of the chassis 201.

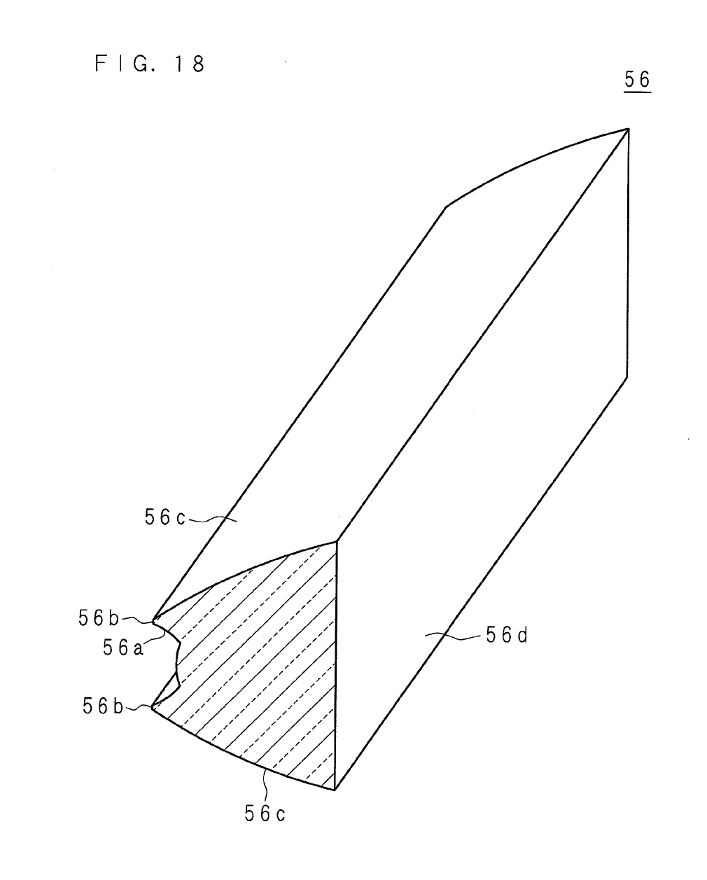

A lens 56 as an optical member for varying the direction of light emission from the LED module 202 is attached to the LED module 202. FIG. 18 is a schematic perspective view of the lens 56 used in the lighting apparatus 500 in Embodiment 5.

The lens 56 is provided with a light incident surface 56a which has a curved portion symmetrical with respect to a surface perpendicular to the LED substrate 221 including the lines (optical axes) passing through the optical centers of a daylight LED 22 and an incandescent LED 23 of the LED module 202 and on which the light emitted from the daylight LED 22 and the incandescent LED 23 of the LED module 202 is incident; a light reflection surface 56c which has a curved portion symmetrical with respect to the surface perpendicular to the LED substrate 221 and reflects the light incident on the light incident surface 56a; a light exiting surface 56d which has a rectangular plane surface and emits the light incident on the light incident surface 56a and the light reflected by the light reflection surface 56c; and a base surface 56b which is parallel to the light exiting surface 56d and has a function as a holding surface for lens including the edge of the light incident surface 56a and the light reflection surface 56c. Additionally, the light reflection surface 56c is formed appropriately such that the light emitted from the daylight LED 22 and the incandescent LED 23 and being incident on the light incident surface 56a can be reflected in parallel direction with respect to the optical axes of the daylight LED 22 and the incandescent LED 23.

The lens 56 is attached to the LED substrate 221 of the LED module 202 at the side of the base surface 56b for covering the direction of light emission from the daylight LED 22 and the incandescent LED 23 mounted on the LED substrate 221 of the LED module 202. Under this attachment condition, the light emitting surface of the daylight LED 22 and the incandescent LED 23 is aligned to the plane including the peripheral edge of the light incident surface 56a or the side of the lens 56 at the plane.

A light diffusible ring cover 208 covering the LED module 202 and the reflection sheet 204 is attached to the chassis 201. The ring cover 208 has a circular hole at the center. The ring cover 208 is bended such that the side of one surface 208a becomes concave from the central portion towards the outer edge portion, and the angle formed between the one surface 208a and the direction of optical axis of the LED continuously becomes larger from the central portion towards the outer edge portion. Other elements identical to those described above with reference to Embodiment 1 illustrated in FIGS. 3 and 8 are designated with the same reference numerals and a detailed description thereof is omitted herein.

Even in the lighting apparatus 500 related to Embodiment 5, the LED module 202 is not arranged at the outer edge portion of the chassis 201 (the lighting apparatus main body), therefore, the distance between the LED module 202 and the center of the chassis 201 as the attaching location to be attached to an attaching member such as ceiling can be shortened. Compared to a case where the LED module 202 is arranged on the outer edge portion of the chassis 201, the moment acting on the chassis 201 can be reduced so that the deformation of the chassis 201 can be prevented and hence the reliability of the lighting apparatus 500 can be improved. A power supply section 6 is arranged at the central portion of the chassis 201, therefore, the power supply section 6 and the wire connecting the power supply section 6 and the LED module 202 are concentrated at the side of the central portion of the chassis 201 so that the moment acting on the chassis 201 can further be reduced. Therefore, the deformation of the chassis 201 is prevented so that reliability of the lighting apparatus 500 can be improved.

In the lighting apparatus 500 related to Embodiment 5 configured as described above, the light emitted from the LED module 202, as shown by the arrows in FIG. 17, is incident on the light incident surface 56a of the lens 56. A part of the incident light passes through the light exiting surface 56d directly in the direction perpendicular to the light exiting surface 56d, and other part of the incident light is reflected on the light reflection surface 56c and exits from the light exiting surface 56d in the direction perpendicular to the light exiting surface 56d. In other words, by providing the lens 56, the light emitted from the LED module 202 is exited in the direction from the central portion of the lighting apparatus 500 to the outer edge, that is, in the direction from the central portion of the chassis 201 to the outer edge.

Thus, the light exited from the lens 56 is incident on the ring cover 208. A part of the incident light is reflected on the one surface 208a of the ring cover 208 at the side of the chassis 201. Other part of the incident light is diffused inside the ring cover 208 and exits to outside of the lighting apparatus 500 from the ring cover 208. Additionally, the ring cover 208 is formed such that the angle between the one surface 208a and the direction of the optical axis of an LED continuously becomes larger from the central portion towards the outer edge portion. Therefore, the total reflection occurs easily because of the smaller incident angle in a case where the light incident on the ring cover 208 is at the side of the central portion of the ring cover 208, and the diffused reflection occurs easily because of the larger incident angle in a case where the light incident on the ring cover 208 is at the outer edge portion of the ring cover 208. The light reflected at the side of the chassis 201 is reflected on the reflection sheet 204 at the side of the ring cover 208. In this way, the light radiated from the lens 56 can be reflected in many directions since the light radiated from the lens 56 is reflected on the ring cover 208 and the reflection sheet 204. Therefore, the region from the outer edge portion to the central portion of the lighting apparatus 500 can be brighter so that a substantially uniform illumination with less illumination unevenness can be achieved as similar in above-mentioned embodiments.

The direction of light emission from the lens 56 refers to the direction from the central portion of the lighting apparatus 500 to the outer edge portion, that is, the direction from the central portion of the chassis 201 to the outer edge portion. Accordingly, the total reflection occurs easily at the side of the central portion of the ring cover 208 as mentioned above, therefore, there is little direct light passing through the ring cover 208 at the side of the central portion of the ring cover 208, in other words, at the vicinity of the LED module 202. That is, the light directly incident on the ring cover 208 at the vicinity of the LED module 202 and exiting to outside of the lighting apparatus 500 can be reduced so that the direct light emitted from the LED module 202 entering to the eyes of a user can be reduced and hence the glare can be reduced.

The shape of the lens 56 may be the shape which can concentrate light by means of bending the light emitted from the daylight LED 22 and the incandescent LED 23 into the direction nearly parallel to the optical axes of the daylight LED 22 and the incandescent LED 23. The present Embodiment 5 is configured to provide one lens 56 for one LED module 202, however, it is not only limited to this case. Each one lens may be provided to each LED. In this case, truncated conical lenses are parallel arranged corresponding to the number of LEDs. Additionally, a lens linked to a part of the plurality of truncated conical lens may be formed.

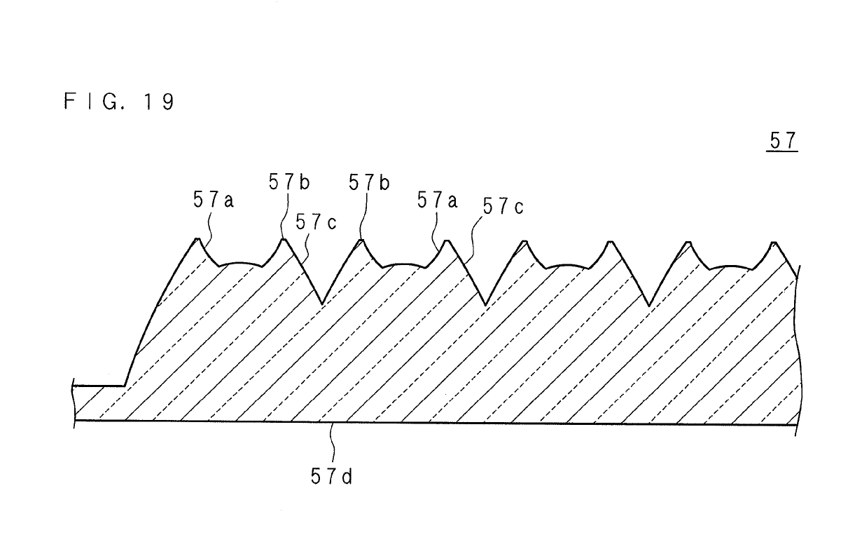

FIG. 19 is a schematic cross-sectional view showing an example of other applicable lens in Embodiment 5. FIG. 19 is an example of a lens linked to a part of a plurality of truncated conical lens. FIG. 19 is an intercept schematic cross sectional view of a lens 57 at the plane perpendicular to the LED substrate 221 including the optical axes of the daylight LED 22 and the incandescent LED 23 of the LED module 202.

The lens 57 is provided with a light incident surface 57a which has a curved portion symmetrical with respect to an optical axis of each LED and on which the light emitted from the daylight LED 22 and the incandescent LED 23 of the LED module 202 is incident; a light reflection surface 57c which has a curved portion symmetrical with respect to the optical axis of each LED reflects the light incident on the light incident surface 57a; a light exiting surface 57d which has a rectangular plane surface and emits the light incident on the light incident surface 57a and the light reflected by the light reflection surface 57c; and a base surface 57b which is parallel to the light exiting surface 57d and has a function as a holding surface for lens including the edge of the light incident surface 57a and the light reflection surface 57c. Additionally, the light reflection surface 57c is formed appropriately such that the light emitted from the daylight LED 22 and the incandescent LED 23 and being incident on the light incident surface 57a can be reflected in parallel direction with respect to the optical axes of the daylight LED 22 and the incandescent LED 23.

The lens 57, as similar to the lens 56, is used to be attached to the LED substrate 221 of the LED module 202 at the side of the base surface 57b to cover the direction of light emission from the daylight LED 22 and the incandescent LED 23 mounted on the LED substrate 21 of the LED module 202. In the case where the lens 57 is used, the similar effect is achieved as in the case where the lens 56 is used.

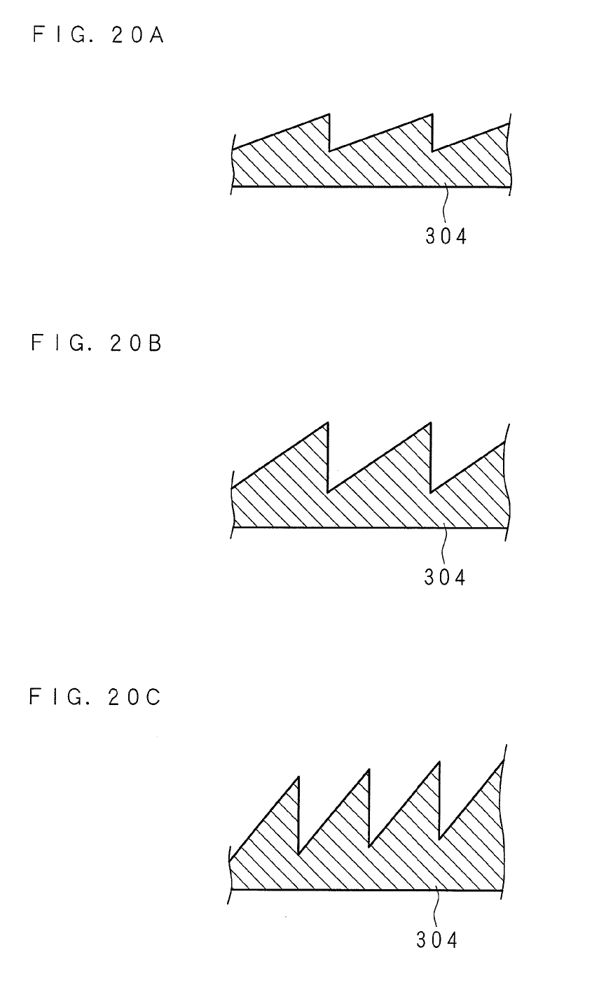

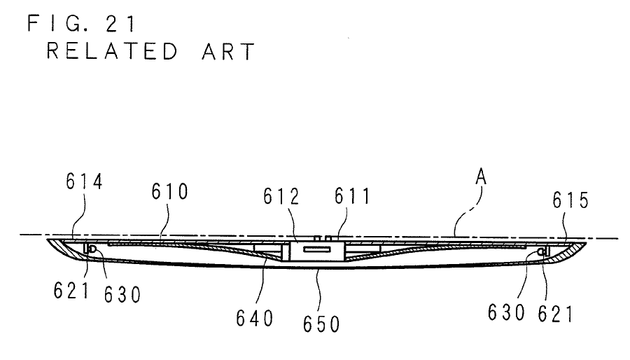

In Embodiments 1 to 5 described above, a plane sheet as the reflection sheet is used. However, it is not limited to this case. A protrusion having an inclined surface inclined towards the LED module may also be provided. FIGS. 20A to 20C are explanation drawings of protrusions provided at the reflection sheet 304. The projection height of a protrusion is getting higher and the space between neighboring protrusions is getting narrower according to the direction from the central portion to the outer edge portion of the lighting apparatus, that is, the direction from the central portion to the outer edge portion of the chassis. In detail, at one surface of the reflection sheet 304 at the side of the central portion of the chassis, a moderate inclined surface is provided and the space between protrusions is wider (see FIG. 20A), at the middle portion between the central portion and the outer edge portion, a larger inclined surface is provided than the surface provided at the central portion and the space between protrusions is narrower (see FIG. 20B), at the outer edge portion, a further larger inclined surface is provided and the space between protrusions is further narrower (see FIG. 20C).

In this way, by varying the inclined angle and the space of the protrusion formed on the reflection sheet 304, the incident angle formed between the light incident upon the reflection sheet 304 and the reflection sheet 304 is larger so that the diffused reflection occurs easily as moving towards the outer edge portion of the reflection sheet 304. Accordingly, the light emitted from the LED module can be reflected on the reflection sheet 304 in many directions so that the outer edge portion and the central portion of the lighting apparatus can be brighter. Therefore, a substantially uniform illumination with less illumination unevenness can be achieved as similar to the above-mentioned embodiments.

Moreover, in above embodiments, the LED substrate may be arranged as an octagonal shape on the chassis, however, it is not limited to this case. The LED substrate may also be arranged in a polygon shape other than octagonal or circular shape.

Moreover, in all embodiments, the reflection sheet and the top reflection sheet are used as the reflecting member, however, the reflection sheet only may also be used as the reflecting member. Additionally, besides using the reflection sheet as the reflecting section, one surface (inner surface) of the chassis may also be used as the reflection surface without using the reflection sheet. Moreover, the reflection sheet is arranged on one side of the center and the outer edge of the chassis, however, the reflection surface may be arranged on one other side. Similarly, the inner surface of the holding section of the light source holding section may be used as the reflection surface without using the top plate reflection sheet as the reflecting section. With regard to the configuration described in Embodiments 1 to 5 and the configuration of providing a protrusion at one surface of the reflection sheet, some embodiments may also be combined together appropriately to further achieve a substantially uniform illumination with less illumination unevenness.

The light source holding section is provided at the chassis separately in above embodiments. However, the light source holding section may be integrated into the chassis.

In above embodiments, the LED module is provided at the central portion of the chassis, however, it is not necessary to arrange the LED module at the exact center of the chassis. For example, the LED module may be arranged to surround the periphery of an adaptor in the radial direction so as to be configured to emit the light to the outer edge portion, the deformation such as bending of the chassis may be prevented.

With regard to the light source elements with different color temperatures, two kinds of light source elements with daylight color and incandescent color are used. However, it is not limited to this case. One kind of light source element may be used, or more than three kinds of light source elements may also be used as the light sources with different color temperatures. In above embodiments, an LED is used as the light source, however, it is not limited to this case. EL (Electro Luminescence) may also be used as the light source.

An example of a lighting apparatus to be attached to a demountable attaching body such as suspended ceiling body attached to an attaching member such as ceiling is illustrated in above embodiments, however, it is not limited to this case. Other types of lighting apparatus may also be applicable.

Furthermore, with regard to this invention, it is needless to say that the scope of matter described in claims can be practiced by other modified modes.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-8. (canceled)

9. A lighting apparatus comprising:
a light source provided at the central side of a lighting apparatus main body; and
a reflecting section reflecting light emitted from the light source,
wherein the light source emits light towards an outer edge portion of the lighting apparatus main body, and then the light is reflected on the reflecting section to perform illumination.

10. The lighting apparatus according to claim 9,
wherein the reflecting section includes a reflection surface opposite to the direction of light emission from the light source.

11. The lighting apparatus according to claim 9, further comprising
another reflecting section, provided at the opposite side of the reflecting section with respect to the light source, and reflecting light emitted from the light source to the side of the reflecting section.

12. The lighting apparatus according to claim 9,
wherein the light source includes a plurality of light source elements with different color temperature, and
the light source element with higher color temperature is arranged at the farther side from the reflecting section than the light source element with lower color temperature.

13. The lighting apparatus according to claim 9, further comprising
a light-diffusible cover covering the light source and the reflecting section,
wherein an inclined portion inclined towards the reflecting section is provided at the outer edge portion of the cover.

14. The lighting apparatus according to claim 9, further comprising
a power supply section, provided at the central side of the lighting apparatus main body, and supplying power to the light source; and
a power supply cover covering the power supply section,
wherein a peripheral edge portion of the power supply cover is transparent to light.

15. The lighting apparatus according to claim 9,
wherein the light source includes a plurality of light source elements, and
at least one of the plurality of light source elements can be lighted up individually.

16. The lighting apparatus according to claim 9,
wherein the light source includes an LED.
